(19) United States
(12) Patent Application Publication
(10) Pub. No.: US 2023/0129722 A1
(43) Pub. Date: Apr. 27, 2023

(54) HEATER ELEMENT WITH FUNCTIONAL MATERIAL-CONTAINING LAYER AND VEHICLE COMPARTMENT PURIFICATION SYSTEM

(71) Applicants: NGK Insulators, Ltd., Nagoya-City (JP); Honda Motor Co., Ltd., Tokyo (JP)

(72) Inventors: Yukio MIYAIRI, Nagoya-City (JP); Masaaki MASUDA, Nagoya-City (JP); Takuya NAKASHIMA, Nagoya-City (JP); Yusuke BABA, Nagoya-City (JP); Subaru MATSUMOTO, Tokyo (JP)

(73) Assignees: NGK Insulators, Ltd., Nagoya-City (JP); Honda Motor Co., Ltd., Tokyo (JP)

(21) Appl. No.: 17/931,172

(22) Filed: Sep. 12, 2022

(30) Foreign Application Priority Data
Sep. 24, 2021 (JP) 2021-156063

(51) Int. Cl. B60H 1/22; B01D 53/04; B60H 3/00; B60H 3/06

(52) U.S. Cl. CPC B60H 1/2225; B01D 53/0438; B60H 3/0092; B60H 3/0658; B01D 2257/80; B01D 2257/504; B01D 2259/4009; B01D 2259/4566; B60H 2003/0691

(57) ABSTRACT

A heater element including a honeycomb structure and a functional material-containing layer, wherein the honeycomb structure has an outer peripheral wall and partition walls provided inside the outer peripheral wall, the partition walls partitioning a plurality of cells that form flow paths extending from an inlet end surface to an outlet end surface, and at least the partition walls are made of a material having PTC characteristics, and wherein the functional material-containing layer is provided on a surface of the partition walls, and a thickness of the functional material-containing layer increases from the inlet end surface toward the outlet end surface.

### CROSS REFERENCE TO RELATED APPLICATIONS

The present invention claims the benefit of priority to Japanese Patent Application No. 2021-156063 filed on Sep. 24, 2021 with the Japanese Patent Office, the entire contents of which are incorporated herein by reference in its entirety.

### FIELD OF THE INVENTION

The present invention relates to a heater element with a functional material-containing layer and a vehicle compartment purification system.

### BACKGROUND OF THE INVENTION

In various vehicles such as automobiles, there is an increasing demand for improvement of vehicle compartment. Specific requirements include reducing CO₂ in the vehicle compartment to suppress driver drowsiness, controlling the humidity in the vehicle compartment, and removing harmful volatile components such as odor components and allergy-inducing components in the vehicle compartment, and the like. Ventilation can be mentioned as an effective measure to meet such demands, but ventilation causes a large loss of heater energy in winter and causes deterioration of energy efficiency in winter. In particular, in an electric vehicle (BEV: Battery Electric Vehicle), there is a problem that the cruising range is significantly reduced due to the energy loss.

As methods for solving the above problem, Patent Literature 1 and Patent Literature 2 discloses a vehicle compartment purification system which captures components to be removed such as water vapor and CO₂ in the air of a vehicle compartment with a functional material such as an adsorbent, and reacts or desorbs the components to be removed by heating to release them to the outside of the vehicle to regenerate the functional material. In such a vehicle compartment purification system, it is required that the air and the functional materials come into contact with each other as much as possible in order to secure the capture performance of the component to be removed, and that the functional material can be heated to a predetermined temperature in order to promote the regeneration of the functional material. Regeneration is accomplished, for example, by a method of removing the substance adsorbed on the functional material by an oxidation reaction, and a method of desorbing the substance adsorbed on the functional material to discharge the substance. However, in any case, it is necessary to heat the functional material to an appropriate temperature according to the adsorbed substance.

On the other hand, Patent Literature 3 discloses a heater element, comprising a pillar-shaped honeycomb structure portion having an outer peripheral side wall, and partition walls provided inside the outer peripheral side wall, the partition walls partitioning a plurality of cells forming flow paths from a first end surface to a second end surface, wherein the partition walls have PTC characteristics, an average thickness of the partition walls is 0.13 mm or less, and an open frontal area on the first and second end surfaces is 0.81 or more. This heater element is used for a heater for heating a vehicle compartment.

### PRIOR ART

Patent Literature
[Patent Literature 1] Japanese Patent Application Publication No. 2020-104774
[Patent Literature 2] Japanese Patent Application Publication No. 2020-111282
[Patent Literature 3] WO 2020/036067

### SUMMARY OF THE INVENTION

The heater element described in Patent Literature 3 is used for heating a vehicle compartment, and it is an efficient heating means because it has a honeycomb structure and can increase the heating area. Therefore, it is considered that the use of such a heater element as a carrier of the functional material can contribute to shortening the regeneration time of the functional material.

In particular, since the heater element described in Patent Literature 3 can be heated by energization and has PTC characteristics, it is considered the functional material can be easily heated, while excessive heat generation can be suppressed and thermal deterioration of the functional material can be suppressed. In addition, since the risk of excessive temperature is avoided, safety can be ensured even if the initial resistance is set low to increase the heating rate, and the temperature can be raised in a short time.

However, as a result of the study of the present inventors, when a functional material-containing layer is provided on the surface of the partition walls which partition the cells of the heater element described in Patent Literature 3, it is difficult for the temperature to rise near the inlet side of the heater element, thereby it is difficult for the functional material carried near the inlet side to rise in temperature. Therefore, the functional material carried near the inlet side has low regeneration efficiency and cannot be effectively used. Further, when the functional material is a catalyst, heating may be required to activate the catalyst, but if the temperature rise of the catalyst carried near the inlet side is insufficient, the catalyst cannot be effectively utilized. Providing a functional material-containing layer that cannot be effectively utilized is a factor that lowers the cost performance of the heater element.

The present invention has been created in view of the above circumstances, and in one embodiment, an object of the present invention is to provide a heater element with a functional material-containing layer having improved cost performance. Further, in another embodiment, an object of the present invention is to provide a vehicle compartment purification system provided with such a heater element with a functional material-containing layer.

According to one embodiment of the present invention, there is provided a heater element, comprising a honeycomb structure and a functional material-containing layer,
wherein the honeycomb structure has an outer peripheral wall and partition walls provided inside the outer peripheral wall, the partition walls partitioning a plurality of cells that form flow paths extending from an inlet end surface to an outlet end surface, and at least the partition walls are made of a material having PTC characteristics, and
wherein the functional material-containing layer is provided on a surface of the partition walls, and a thickness of the functional material-containing layer increases from the inlet end surface toward the outlet end surface.

According to another embodiment of the present invention, there is provided a vehicle compartment purification system, comprising:
at least one said heater element;
a power supply for applying a voltage to the heater element;
an inflow piping communicating the vehicle compartment with the inlet end surface of the heater element;
an outflow piping having a first path communicating the outlet end surface of the heater element with the vehicle compartment; and
a ventilator for allowing air from the vehicle compartment to flow into the inlet end surface of the heater element via the inflow piping.

According to one embodiment of the present invention, it is possible to improve the cost performance of the heater element with a functional material-containing layer. More specifically, the heater element has a large thickness of the functional material-containing layer in places where the temperature tends to rise, that is, where the functional material can be easily regenerated. Therefore, it is possible to reduce the proportion of functional material that is difficult to regenerate and is not effectively utilized and/or that is not effectively utilized due to insufficient functioning resulted from insufficient temperature rise.

### BRIEF DESCRIPTION OF THE DRAWINGS

FIG. 1 is a schematic perspective view of a heater element according to an embodiment of the present invention.

FIG. 2 is a schematic cross-sectional view orthogonal to the flow path direction of a heater element according to an embodiment of the present invention.

FIG. 3A is a schematic view of a cross-section parallel to the flow path direction and passing through a central axis O extending in the flow path direction in a heater element according to an embodiment of the present invention (Embodiment 1).

FIG. 3B is a schematic view of a cross-section parallel to the flow path direction and passing through a central axis O extending in the flow path direction in a heater element according to an embodiment of the present invention (Embodiment 2).

FIG. 3C is a schematic view of a cross-section parallel to the flow path direction and passing through a central axis O extending in the flow path direction in a heater element according to an embodiment of the present invention (Embodiment 3).

FIG. 3D is a schematic view of a cross-section parallel to the flow path direction and passing through a central axis O extending in the flow path direction in a heater element according to an embodiment of the present invention (Embodiment 4).

FIG. 3E is a schematic view of a cross-section parallel to the flow path direction and passing through a central axis O extending in the flow path direction in a heater element according to an embodiment of the present invention (Embodiment 5).

FIG. 3F is a schematic view of a cross-section parallel to the flow path direction and passing through a central axis O extending in the flow path direction in a heater element according to an embodiment of the present invention (Embodiment 6).

FIG. 4 is a schematic diagram showing a configuration of a vehicle compartment purification system according to an embodiment of the present invention.

FIG. 5 is a contour diagram showing a temperature distribution inside a honeycomb structure by simulation.

### DETAILED DESCRIPTION OF THE INVENTION

Hereinafter, embodiments of the present invention will now be described in detail with reference to the drawings. It should be understood that the present invention is not intended to be limited to the following embodiments, and any change, improvement or the like of the design may be appropriately added based on ordinary knowledge of those skilled in the art without departing from the spirit of the present invention.

### 1. Heater Element with Functional Material-Containing Layer

The heater element with a functional material-containing layer (hereinafter, abbreviated as “heater element”) according to an embodiment of the present invention can be suitably used as a heater element used in a vehicle compartment purification system in various vehicles such as automobiles. Vehicles are not particularly limited, and examples thereof include automobiles and electric trains. Examples of automobiles include, but are not limited to, gasoline-powered vehicles, diesel-powered vehicles, gas-fueled vehicles using CNG (Compressed Natural Gas), LNG (Liquefied Natural Gas), fuel cell vehicles, electric vehicles, and plug-in hybrid vehicles. The heater element according to the embodiment of the present invention can be particularly suitably used for vehicles having no internal combustion engine such as an electric vehicle and an electric train.

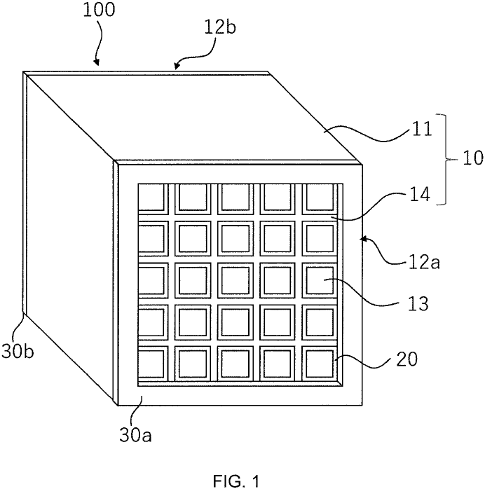

As shown in FIGS. 1, 2 and 3A-3F, the heater element 100 comprises a honeycomb structure 10 and a functional material-containing layer 20, wherein the honeycomb structure 10 has an outer peripheral wall 11 and partition walls 14 provided inside the outer peripheral wall 11, the partition walls 14 partitioning a plurality of cells 13 that form flow paths extending from an inlet end surface 12a to an outlet end surface 12b , and the functional material-containing layer 20 is provided on a surface of the partition walls 14. Further, the heater element 100 can further comprise a pair of electrodes 30a and 30b provided on the inlet end surface 12a and the outlet end surface 12b of the honeycomb structure 10. Note that, in the present specification, the components composed of the honeycomb structure 10 excluding the functional material-containing layer 20 from the heater element 100 and the pair of electrodes 30a and 30b is referred to as a “honeycomb heater device”.

Hereinafter, each component of the heater element 100 will be described in detail.

### 1-1 Honeycomb Structure

The shape of the honeycomb structure 10 is not particularly limited. For example, the outer shape of the cross-section orthogonal to the flow path direction (direction in which the cells 13 extend) of the honeycomb structure 10 can be polygonal (quadrangle (rectangle, square), pentagon, hexagon, heptagon, octagon, and the like), circular, oval (egg-shape, ellipse, oval, rounded rectangle, and the like). In addition, the end surfaces (inlet end surface 12a and outlet end surface 12b) have the same shape as the cross-section. When the cross-section and the end surfaces are polygonal, the corners may be chamfered.

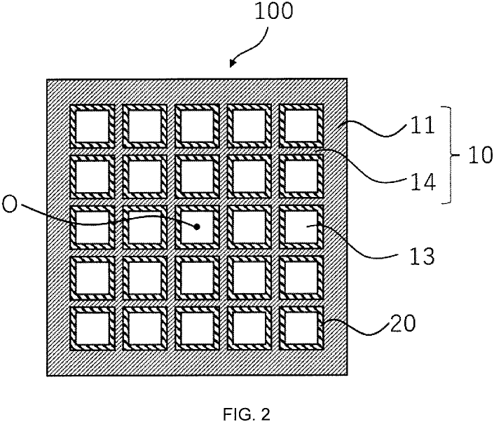

The shape of the cells 13 is not particularly limited, and in the cross-section of the honeycomb structure 10 orthogonal to the flow path direction, it can be polygonal (quadrangle, pentagon, hexagon, heptagon, octagon, and the like), circular, or oval. The shapes may be uniform or may be a combination of two or more. Further, among these shapes, a quadrangle or a hexagon is preferable. By providing the cells 13 having such a shape, it is possible to reduce the pressure loss when the air flows. Note that, FIGS. 1 and 2 show, as an example, a honeycomb structure 10 in which the outer shape of the cross-section and the shape of the cells 13 are quadrangular in the cross-section orthogonal to the flow path direction.

The honeycomb structure 10 may be a honeycomb joint body having a plurality of honeycomb segments and a joining layer for joining the outer peripheral side surfaces of the plurality of honeycomb segments. By using the honeycomb joint body, it is possible to increase the total cross-sectional area of the cells 13, which is important for securing the air flow rate, while suppressing the occurrence of cracks.

In addition, the joining layer can be formed by using a joining material. The joining material is not particularly limited, but a ceramic material to which a solvent such as water is added to form a paste can be used. The joining material may contain a material having PTC (Positive Temperature Coefficient) characteristics, or may contain the same material as the outer peripheral wall 11 and the partition walls 14. In addition to the role of joining the honeycomb segments to each other, the joining material can also be used as an outer peripheral coating material after joining the honeycomb segments.

From the viewpoints of ensuring the strength of the honeycomb structure 10, reducing the pressure loss when the air passes through the cells 13, securing the amount of the functional material carried, and securing the contact area with the air flowing in the cells 13, and the like, it is desirable to combine the thickness of the partition walls 14, the cell density, and the cell pitch (or the open frontal area of the cells) appropriately.

In the present specification, the thickness of the partition wall 14 refers to a crossing length of a line segment that crosses the partition wall 14 when the centers of gravity of adjacent cells 13 are connected by this line segment in a cross-section orthogonal to the flow path direction of the honeycomb structure 10. The thickness of the partition walls 14 refers to the average value of the thicknesses of all the partition walls 14.

In the present specification, the cell density is a value obtained by dividing the number of cells by the area of one end surface of the honeycomb structure 10 (the total area of the partition walls 14 and the cells 13 excluding the outer peripheral wall 11).

In the present specification, the cell pitch refers to a value obtained by the following calculation. First, the area per cell is calculated by dividing the area of one end surface of the honeycomb structure 10 (the total area of the partition wall 14 and the cells 13, excluding the outer peripheral wall 11) by the number of cells. Next, the square root of the area per cell is calculated, and this is deemed as the cell pitch.

In the present specification, the open frontal area of the cells is a value obtained by dividing the total area of the cells 13 partitioned by the partition walls in a cross-section orthogonal to the flow path direction of the honeycomb structure 10 by the area of one end surface (the total area of the partition walls 14 and the cells 13, excluding the outer peripheral wall 11). Note that, in calculating the open frontal area of the cells, the functional material-containing layer 20 is not taken into consideration.

In an embodiment advantageous from the viewpoint of carrying a sufficient amount of functional material, the thickness of the partition walls is 0.125 mm or less, the cell density is 100 cells/cm² or less, and the cell pitch is 1.0 mm or more. In a preferred embodiment, the thickness of the partition walls is 0.100 mm or less, the cell density is 70 cells/cm² or less, and the cell pitch is 1.2 mm or more. In a more preferable embodiment, the thickness of the partition walls is 0.080 mm or less, the cell density is 65 cells/cm² or less, and the cell pitch is 1.3 mm or more.

In each of the above embodiments, from the viewpoint of ensuring the strength of the honeycomb structure and keeping the electrical resistance low, the lower limit of the thickness of the partition walls is preferably 0.010 mm or more, more preferably 0.020 mm or more, and even more preferably 0.030 mm or more.

In each of the above embodiments, from the viewpoint of ensuring the strength of the honeycomb structure, keeping the electric resistance low, and increasing the surface area to promote the reaction, adsorption and desorption, the lower limit of the cell density is preferably 30 cells/cm² or more, more preferably 35 cells/cm² or more, and even more preferably 40 cells/cm² or more.

In each of the above embodiments, from the viewpoint of ensuring the strength of the honeycomb structure, keeping the electric resistance low, and increasing the surface area to promote the reaction, adsorption and desorption, the upper limit of the cell pitch is preferably 2.0 mm or less, more preferably 1.8 mm or less, and even more preferably 1.6 mm or less.

In an embodiment advantageous from the viewpoint of reducing pressure loss and maintaining strength, the thickness of the partition walls is 0.08 mm or more and 0.36 mm or less, and the cell density is 2.54 cells/cm² or more and 140 cells/cm² or less, and the open frontal area of the cells is 0.80 or more. In a preferred embodiment, the thickness of the partition walls is 0.09 mm or more and 0.35 mm or less, the cell density is 15 cells/cm² or more and 100 cells/cm² or less, and the open frontal area of the cells is 0.83 or more. In a more preferable embodiment, the thickness of the partition walls is 0.14 mm or more and 0.30 mm or less, the cell density is 20 cells/cm² or more and 90 cells/cm² or less, and the open frontal area of the cells is 0.85 or more.

In each of the above embodiments, from the viewpoint of ensuring the strength of the honeycomb structure, the upper limit of the open frontal area of the cells is preferably 0.94 or less, more preferably 0.92 or less, and even more preferably 0.90 or less.

The thickness of the outer peripheral wall 11 is not particularly limited, but is preferably determined based on the following viewpoints. First, from the viewpoint of reinforcing the honeycomb structure 10, the thickness of the outer peripheral wall 11 is preferably 0.05 mm or more, more preferably 0.06 mm or more, even more preferably 0.08 mm or more. On the other hand, from the viewpoint of increasing the electrical resistance to suppress the initial current and reducing the pressure loss when the air flows, the thickness of the outer peripheral wall 11 is preferably 1.0 mm or less, more preferably 0.5 mm or less, even more preferably 0.4 mm or less, even more preferably 0.3 mm or less.

In the present specification, the thickness of the outer peripheral wall 11 refers to a length in the normal direction of a side surface from the boundary between the outer peripheral wall 11 and the cell 13 or partition wall 14 on the outermost side to the side surface of the honeycomb structure 10, in a cross-section orthogonal to the flow path direction of the honeycomb structure 10.

The length of the honeycomb structure 10 in the flow path direction and the cross-sectional area orthogonal to the flow path direction may be adjusted according to the required size of the heater element 100, and are not particularly limited. For example, when used for a heater element 100 which is compact while ensuring a predetermined function, the honeycomb structure 10 may have a length of 2 to 20 mm in the flow path direction and a cross-sectional area orthogonal to the flow path direction of 10 cm² or more. The upper limit of the cross-sectional area orthogonal to the flow path direction is not particularly limited, but is, for example, 300 cm² or less.

The partition walls 14 constituting the honeycomb structure 10 is made of a material capable of generating heat by energization, and specifically, is made of a material having PTC characteristics. If necessary, the outer peripheral wall 11 may also be made of a material having PTC characteristics similar to the partition walls 14.

It is possible to heat the functional material-containing layer 20 by heat transfer from the heated partition wall 14 (and the outer peripheral wall 11 if necessary). Further, the material having PTC characteristics has a characteristic that when the temperature rises and exceeds a Curie point, the resistance value rapidly rises and it becomes difficult for electricity to flow. Therefore, when the heater element 100 becomes hot, the electric current flowing through the partition wall 14 (and the outer peripheral wall 11 if necessary) is limited, so that excessive heat generation of the heater element 100 is suppressed. Therefore, it is also possible to suppress thermal deterioration of the functional material-containing layer 20 due to excessive heat generation.

The lower limit of the volume resistivity of the material having PTC characteristics at 25° C. is preferably 0.5 Ω·cm or more, more preferably 1 Ω·cm or more, and even more preferably 5 Ω·cm or more, from the viewpoint of obtaining appropriate heat generation. The upper limit of the volume resistivity of the material having PTC characteristics at 25° C. is preferably 20 Ω·cm or less, more preferably 18 Ω·cm or less, and even more preferably 16 Ω·cm or less, from the viewpoint of generating heat at a low drive voltage. In the present specification, the volume resistivity of a material having PTC characteristics at 25° C. is measured according to JIS K6271: 2008.

From the viewpoint of being able to generate heat when energized and having PTC characteristics, the outer peripheral wall 11 and the partition walls 14 are preferably made of a material containing barium titanate (BaTiOs) as a main component, and more preferably ceramics made of a material containing barium titanate (BaTiO₃) based crystal particles in which a part of Ba is replaced with a rare earth element as a main component. Note that, in this specification, a “main component” means the component accounts for more than 50% by mass in the whole components. The content of BaTiO₃-based crystal particles can be determined by, for example, fluorescent X-ray analysis. The content of other crystal particles can be determined in the same manner as this method.

The composition formula of the BaTiO₃-based crystal particles in which a part of Ba is replaced with a rare earth element can be expressed by (Ba₁₋ₓAₓ) TiO₃. In the composition formula, A represents one or more rare earth elements, and 0.0001 ≤ x ≤ 0.010.

A is not particularly limited as long as it is a rare earth element, but is preferably one or more selected from the group consisting of La, Ce, Pr, Nd, Eu, Gd, Dy, Ho, Er, Y and Yb, and it is more preferably La. x is preferably 0.001 or more, more preferably 0.0015 or more, from the viewpoint of suppressing the electric resistance from becoming too high at room temperature. On the other hand, x is preferably 0.009 or less from the viewpoint of suppressing insufficient sintering that will cause excessively high electrical resistance at room temperature.

The content of BaTiOs-based crystal particles in which a part of Ba is replaced with a rare earth element is not particularly limited as long as it is the main component of the ceramics, but is preferably 90% by mass or more, more preferably 92% by mass or more, and even more preferably 94% by mass or more in the ceramics. In addition, the upper limit of the content of the BaTiO₃-based crystal particles is not particularly limited, but is generally 99% by mass, preferably 98% by mass.

The content of the BaTiO₃-based crystal particles can be determined by, for example, fluorescent X-ray analysis. The content of other crystal particles can be determined in the same manner as this method.

It is desirable that the materials used for the outer peripheral wall 11 and the partition walls 14 substantially contain no lead (Pb) from the viewpoint of reducing the environmental burden. Specifically, the outer peripheral wall 11 and the partition walls 14 preferably have a Pb content of 0.01% by mass or less, more preferably 0.001% by mass or less, and even more preferably 0% by mass. Due to the low Pb content, for example, the air heated by contacting the partition walls 14 generating heat can be safely applied to organisms such as humans. In the outer peripheral wall 11 and the partition walls 14, the Pb content is preferably less than 0.03% by mass, more preferably less than 0.01% by mass, and even more preferably 0% by mass, in terms of PbO. The lead content can be determined by ICP-MS (Inductively Coupled Plasma Mass Spectrometry).

The lower limit of the Curie point of the material constituting the outer peripheral wall 11 and the partition walls 14 is preferably 100° C. or higher, more preferably 110° C. or higher, and more preferably 125° C. or higher, from the viewpoint of efficiently heating the air. In addition, regarding the upper limit of the Curie point, from the viewpoint of safety of a part placed in or near the vehicle compartment, it is preferably 250° C. or lower, more preferably 225° C. or lower, even more preferably 200° C. or lower, and even more preferably 150° C. or lower.

The Curie point of the material constituting the outer peripheral wall and the partition walls can be adjusted by the type and addition amount of a shifter. For example, the Curie point of barium titanate (BaTiO₃) is about 120° C., but the Curie point can be shifted to the low temperature side by replacing a part of Ba and Ti with one or more of Sr, Sn and Zr.

In the present invention, the Curie point is measured by the following method. Attach the sample to a sample holder for measurement, mount it in a measuring tank (for example, MINI-SUBZERO MC-810P manufactured by ESPEC CORP.), and measure the change in the electrical resistance of the sample when the temperature is raised from 10° C. with a DC resistance meter (for example, Multimeter 3478A manufactured by YOKOGAWA HEWLETT PACKARD LTD). From the electric resistance-temperature plot obtained by the measurement, the temperature at which the resistance value becomes twice the resistance value at room temperature (20° C.) is defined as the Curie point.

### 1-2 Functional Material-Containing Layer

The functional material-containing layer 20 is provided on the surface of the partition walls 14 of the honeycomb structure 10. Specifically, the functional material-containing layer 20 is provided on the surface of the partition walls 14 facing the cells 13 of the honeycomb structure 10, that is, on the inner walls of the cells 13. The functional material-containing layer 20 can also be provided on the outer peripheral wall 11 facing the cells 13.

The functional material contained in the functional material-containing layer 20 is not particularly limited as long as it is a material capable of exhibiting a desired function, but an adsorbent, a catalyst, or the like can be used. The adsorbent preferably has a function of adsorbing one or more kinds selected from components to be removed in the air, for example, water vapor, carbon dioxide, and an odor component. In addition, it is also preferable to have a function of adsorbing harmful volatile components. Further, by using a catalyst, the component to be removed can be purified. Further, an adsorbent and a catalyst may be used in combination for the purpose of enhancing the function of capturing the component to be removed by the adsorbent.

The adsorbent preferably has a function such that it is possible to adsorb components to be removed, such as water vapor, carbon dioxide, and harmful volatile components (for example, aldehydes, odor components, and the like) at -20 to 40° C., and release them at a high temperature of 60° C. or higher. Examples of the adsorbent having such a function include zeolite, silica gel, activated carbon, alumina, silica, low crystalline clay, and amorphous aluminum silicate complex, and the like. The type of the adsorbent may be appropriately selected according to the type of the component to be removed. For the adsorbent, one type may be used alone, or two or more types may be used in combination.

The catalyst preferably has a function capable of promoting a redox reaction. Examples of the catalyst having such a function include metal catalysts such as Pt, Pd and Ag, and oxide catalysts such as CeO₂ and ZrO₂. For the catalyst, one type may be used alone, or two or more types may be used in combination.

Harmful volatile components contained in the air of the vehicle compartment are, for example, volatile organic compounds (VOCs) and odor components. Specific examples of harmful volatile components include ammonia, acetic acid, isovaleric acid, nonenal, formaldehyde, toluene, xylene, paradichlorobenzene, ethylbenzene, styrene, chlorpyrifos, di-n-butyl phthalate, tetradecane, di-2-ethylhexyl phthalate, diazinon, acetaldehyde, 2- (1-methylpropyl) phenyl N-methylcarbamate, and the like.

When the heater element 100 is energized to generate heat in order to regenerate the functional material, the temperature of the air flowing into the cells 13 from the inlet end surface 12a of the honeycomb structure 10 is difficult to rise in the vicinity of the inlet side. Therefore, even if a functional material is provided near the inlet, it is difficult to regenerate it, and it cannot be effectively used. Therefore, by increasing the thickness of the functional material-containing layer 20 from the inlet end surface 12a toward the outlet end surface 12b, the ratio of the functional material that can be regenerated among the functional materials provided in the heater element 100 can be increased, and the cost performance can be improved.

Increasing the thickness of the functional material-containing layer 20 from the inlet end surface 12a toward the outlet end surface 12b means that there is a region where the thickness of the functional material-containing layer 20 provided on the surface of the partition walls forming the inner walls of the cells 13 increases stepwise or continuously (gradually) from the inlet end surface 12a toward the outlet end surface 12b, and on the other hand, there is no region where the thickness of the functional material-containing layer 20 decreases stepwise or continuously (gradually) from the inlet end surface 12a toward the outlet end surface 12b.

In a preferred embodiment, there is a region where the thickness of the functional material-containing layer 20 is 0 from the inlet end surface over a predetermined length in the direction in which the flow paths extend (a region where the functional material-containing layer is not provided). This is because it is difficult to effectively utilize the functional material in the vicinity of the inlet end surface 12a. The predetermined length is preferably ⅒ or more and ½ or less, more preferably ⅛ or more and ⅖ or less, and even more preferably ⅙ or more and 3/10 or less, with respect to the length of the honeycomb structure 10 in the direction in which the flow paths extend.

Examples of embodiment in which the thickness of the functional material-containing layer 20 increases from the inlet end surface 12a toward the outlet end surface 12b include, but are not limited to, the following (Embodiment 1) to (Embodiment 6).

### Embodiment 1

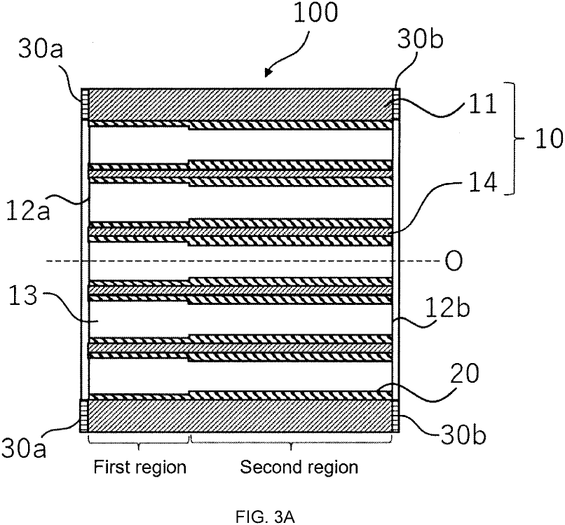

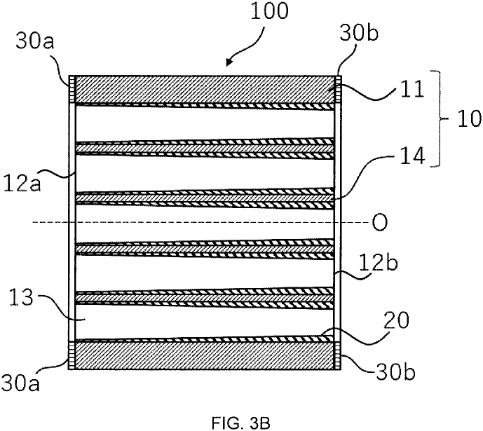

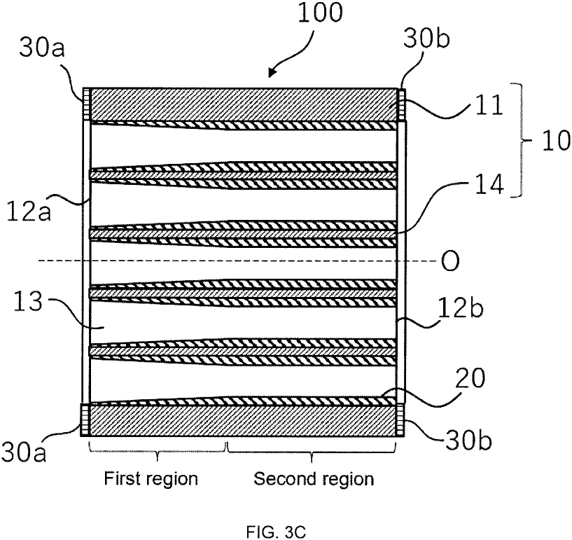

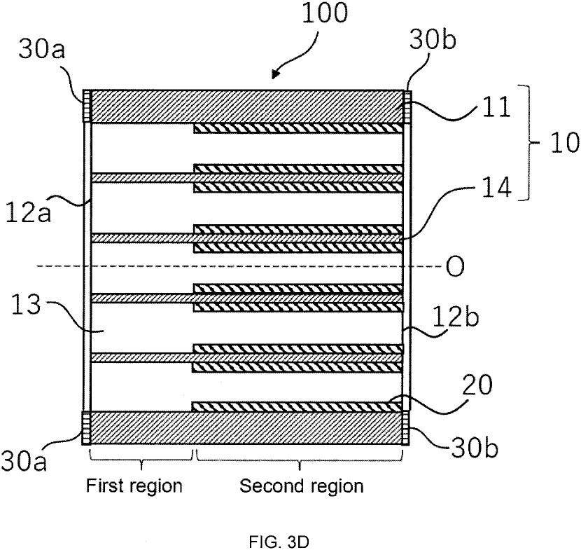

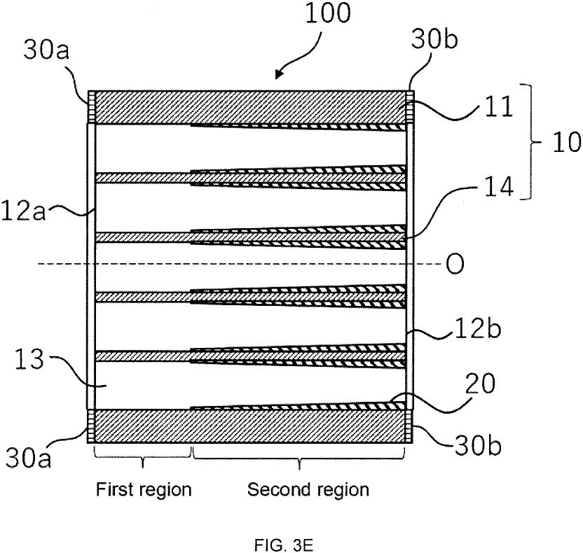

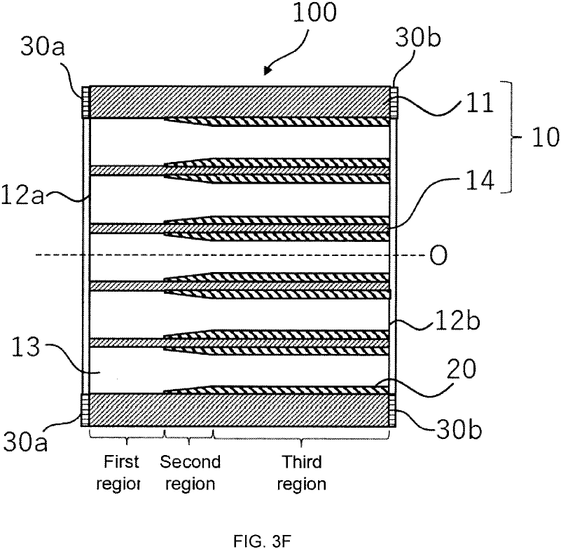

In this embodiment, the thickness of the functional material-containing layer 20 inside the cells 13 always exceeds 0 from the inlet end surface 12a to the outlet end surface 12b. There is a first region extending from the inlet end surface 12a over a predetermined length in the direction in which the flow paths extend, where the thickness of the functional material-containing layer 20 is constant, and there is a second region adjacent to the outlet side end portion of the first region, extending till the outlet end surface 12b in the direction in which the flow paths extend, where the thickness of the functional material-containing layer 20 is larger than the thickness in the first region and the thickness of the functional material-containing layer 20 is constant (FIG. 3A).

In (Embodiment 1), the predetermined length in the direction in which the flow paths extend of the first region is preferably ⅒ or more and ½ or less, more preferably ⅛ or more and ⅖ or less, and even more preferably ⅙ or more and 3/10 or less, with respect to the length of the honeycomb structure 10 in the direction in which the flow paths extend (the distance from the inlet end surface 12a to the outlet end surface 12b).

In (Embodiment 1), “the thickness is constant” means a concept that the thickness is substantially constant, and modest variation is acceptable. Specifically, a region in which the thickness of the functional material-containing layer 20 is continuous from the inlet end surface 12a toward the outlet end surface 12a within a range of ± 10% of the thickness at the inlet side end portion of the first region is regarded as the first region. Similarly, a region in which the thickness of the functional material-containing layer 20 is continuous from the outlet end surface 12b toward the inlet end surface 12a within a range of ± 10% of the thickness at the outlet side end portion of the second region is regarded as the second region.

### Embodiment 2

In this embodiment, the thickness of the functional material-containing layer 20 inside the cells 13 always exceeds 0 from the inlet end surface 12a till the outlet end surface 12b, and the thickness of the functional material-containing layer 20 continuously increases from the inlet end surface 12a toward the outlet end surface 12b (FIG. 3B).

### Embodiment 3

In this embodiment, the thickness of the functional material-containing layer 20 inside the cells 13 always exceeds 0 from the inlet end surface 12a to the outlet end surface 12b. There is a first region extending from the inlet end surface 12a over a predetermined length in the direction in which the flow paths extend, where the thickness of the functional material-containing layer 20 continuously increases toward the outlet end surface 12b, and there is a second region adjacent to the outlet side end portion of the first region, extending till the outlet end surface 12b in the direction in which the flow paths extend, where the thickness of the functional material-containing layer 20 is constant (at the maximum thickness of the first region) till the outlet end surface 12b (FIG. 3C).

In (Embodiment 3), the predetermined length in the direction in which the flow paths extend of the first region is preferably ⅒ or more and ½ or less, more preferably ⅛ or more and ⅖ or less, and even more preferably ⅙ or more and 3/10 or less, with respect to the length of the honeycomb structure 10 in the direction in which the flow paths extend (the distance from the inlet end surface 12a to the outlet end surface 12b).

In (Embodiment 3), “the thickness is constant” means a concept that the thickness is substantially constant, and modest variation is acceptable. Specifically, a region in which the thickness of the functional material-containing layer 20 is continuous from the outlet end surface 12b toward the inlet end surface 12a within a range of ± 10% of the thickness at the outlet side end portion of the second region is regarded as the second region.

### Embodiment 4

In this embodiment, there is a first region where the thickness of the functional material-containing layer 20 is 0 from the inlet end surface 12a over a predetermined length in the direction in which the flow paths extend, and there is a second region adjacent to the outlet side end portion of the first region, extending till the outlet end surface 12b in the direction in which the flow paths extend, where the thickness of the functional material-containing layer 20 exceeds 0 and the thickness of the functional material-containing layer 20 is constant (FIG. 3D).

In (Embodiment 4), the predetermined length in the direction in which the flow paths extend of the first region is preferably ⅒ or more and ½ or less, more preferably ⅛ or more and ⅖ or less, and even more preferably ⅙ or more and 3/10 or less, with respect to the length of the honeycomb structure 10 in the direction in which the flow paths extend (the distance from the inlet end surface 12a to the outlet end surface 12b).

In (Embodiment 4), “the thickness is constant” means a concept that the thickness is substantially constant, and modest variation is acceptable. Specifically, a region in which the thickness of the functional material-containing layer 20 is continuous from the outlet end surface 12b toward the inlet end surface 12a within a range of ± 10% of the thickness at the outlet side end portion of the second region is regarded as the second region.

### Embodiment 5

In this embodiment, there is a first region where the thickness of the functional material-containing layer 20 is 0 from the inlet end surface 12a over a predetermined length in the direction in which the flow paths extend, and there is a second region adjacent to the outlet side end portion of the first region, extending till the outlet end surface 12b in the direction in which the flow paths extend, where the thickness of the functional material-containing layer 20 exceeds 0, and the thickness of the functional material-containing layer 20 continuously increases toward the outlet end surface 12b. (FIG. 3E).

In (Embodiment 5), the predetermined length in the direction in which the flow paths extend of the first region is preferably ⅒ or more and ½ or less, more preferably ⅛ or more and ⅖ or less, and even more preferably ⅙ or more and 3/10 or less, with respect to the length of the honeycomb structure 10 in the direction in which the flow paths extend (the distance from the inlet end surface 12a to the outlet end surface 12b).

### Embodiment 6

In this embodiment, there is a first region where the thickness of the functional material-containing layer 20 is 0 from the inlet end surface 12a over a predetermined length in the direction in which the flow paths extend; and there is a second region adjacent to the outlet side end portion of the first region, extending over a predetermined length in the direction in which the flow paths extend, wherein the thickness of the functional material-containing layer 20 continuously increases toward the outlet end surface 12b; and there is a third region adjacent to the outlet side end portion of the second region, extending till the outlet end surface 12b in the direction in which the flow paths extend, wherein the thickness of the functional material-containing layer 20 is constant (at the maximum thickness of the second region) till the outlet end surface 12b (FIG. 3F).

In (Embodiment 6), the predetermined length in the direction in which the flow paths extend of the first region is preferably ¼ or more and ⅓ or less with respect to the length of the honeycomb structure 10 in the direction in which the flow paths extend (the distance from the inlet end surface 12a to the outlet end surface 12b).

In (Embodiment 6), the predetermined length in the direction in which the flow paths extend of the second region is preferably ⅙ or more and ¼ or less with respect to the length of the honeycomb structure 10 in the direction in which the flow paths extend (the distance from the inlet end surface 12a to the outlet end surface 12b).

In (Embodiment 6), “the thickness is constant” means a concept that the thickness is substantially constant, and modest variation is acceptable. Specifically, a region in which the thickness of the functional material-containing layer 20 is continuous from the outlet end surface 12b toward the inlet end surface 12a within a range of ± 10% of the thickness at the outlet side end portion of the third region is regarded as the third region.

Among (Embodiment 1) to (Embodiment 6), (Embodiment 4) to (Embodiment 6) are preferable and Embodiment 6) is more preferable because the ratio of the functional material-containing layer 20 that can be effectively utilized can be increased and the electric power at the time of heating the functional material-containing layer 20 can be reduced.

In any of the embodiments, from the viewpoint of suppressing the pressure loss to a low level, the thickness of the functional material-containing layer 20 is preferably 300 µm or less at the maximum, more preferably 250 µm or less at the maximum, and even more preferably 200 µm or less at the maximum.

In any of the embodiments, in order for the functional material to exert the desired function in the heater element 100, it is advantageous to have a continuous region extending with a length of ½ or more and 9/10 or less, preferably ⅗ or more and ⅞ or less, with respect to the length the flow paths (the distance from the inlet end surface 12a to the outlet end surface 12b), where the thickness of the functional material-containing layer 20 is 1/100 or more and ⅓ or less, preferably 1/50 or more and ¼ or less of a hydraulic diameter of the cells 13.

The hydraulic diameter of the cells is a value (P - t) obtained by subtracting the thickness t (mm) of the partition walls from the cell pitch P (mm) described above.

The thickness of the functional material-containing layer 20 is evaluated by the following procedure. As exemplified in FIGS. 3A to 3F, an arbitrary cross-section that is parallel to the flow path direction and passes through a central axis O extending in the flow path direction of the honeycomb structure 10 is cut out, and a cross-sectional image of magnification of about 50 times is obtained with a scanning electron microscope or the like. The position of the central axis O is the position of the center of gravity in the cross-section orthogonal to the flow path direction of the honeycomb structure 10 (see FIG. 2). For all the functional material-containing layers 20 visible from the cross-sectional image, the profile of the outer surface of the functional material-containing layer 20 is drawn. Then, an average profile of all the obtained profiles is created. Based on the average profile, the change in the thickness of the functional material-containing layer 20 in the heater element 100 is investigated. It is also determined based on the average profile whether it is any one of the above Embodiments 1 to 6 or any other. When a region having a constant thickness is recognized based on the above-mentioned investigation result of the thickness change, the average value of the thickness of the region is defined as the thickness in the region. The maximum thickness of the functional material-containing layer 20 is the maximum thickness measured based on all the profiles of the outer surface of the functional material-containing layer 20 obtained in the above procedure. Note that the thickness of the functional material-containing layer 20 is measured in a direction perpendicular to the direction in which the flow paths extend.

From the viewpoint that the functional material exerts a desired function in the heater element 100, the amount of the functional material-containing layer 20 is preferably 50 g/L or more and 500 g/L or less, more preferably 100 g/L or more and 400 g/L or less, and even more preferably 150 g/L or more and 350 g/L or less, with respect to the volume of the honeycomb structure 10. Note that the volume of the honeycomb structure 10 is a value determined by the external dimensions of the honeycomb structure 10.

### 1-3. Electrodes

The heater element 100 according to one embodiment of the present invention can comprise a pair of electrodes 30a and 30b provided on the inlet end surface 12a and the outlet end surface 12b of the honeycomb structure 10. The heater element 100 of the embodiment shown in FIG. 1 comprises a pair of electrodes 30a and 30b on the surface of the outer peripheral wall 11 on the inlet end surface 12a and the outlet end surface 12b of the honeycomb structure 10. The pair of electrodes 30a and 30b may be provided on the surface of the partition walls 14 that forms the inlet end surface 12a (the outlet end surface 12b) instead of, or in addition to the surface of the outer peripheral wall 11 that forms the inlet end surface 12a (outlet end surface 12b). Further, they may be additionally provided on the surface of the partition walls 14 that form the inner wall of the cells 13. It is preferable that all the portions constituting each electrode be connected to each other.

Alternatively, the pair of electrodes 30a and 30b can be provided on the outer peripheral side surfaces facing each other with the central axis extending in the flow path direction of the honeycomb structure 10 interposed therebetween.

By applying a voltage between the pair of electrodes 30a and 30b, the honeycomb structure 10 can generate heat by Joule heat. The pair of electrodes 30a and 30b may have an extended portion extending outward of the honeycomb structure 10. By providing the extended portion, it becomes easy to connect to connectors which are responsible for the connection with the external equipment.

The electrodes 30a and 30b are not particularly limited, and for example, a metal or alloy containing at least one selected from Cu, Ag, Al, Ni and Si can be used. It is also possible to use an ohmic electrode capable of ohmic contact with the outer peripheral wall 11 and/or the partition walls 14 having PTC characteristics. As the ohmic electrode, for example, an ohmic electrode containing at least one selected from Au, Ag and In as a base metal and at least one selected from Ni, Si, Ge, Sn, Se and Te for n-type semiconductors as a dopant can be used. Further, the electrodes 30a and 30b may have a one-layer structure or a laminated structure with two or more layers. When the electrodes 30a and 30b have a laminated structure of two or more layers, the materials of the respective layers may be the same type or different types.

The thicknesses of the electrodes 30a and 30b are not particularly limited and can be appropriately set according to the method of forming the electrodes 30a and 30b. Examples of the method for forming the electrodes 30a and 30b include metal deposition methods such as sputtering, vapor deposition, electrolytic deposition, and chemical deposition. Further, the electrodes 30a and 30b can also be formed by a method of applying an electrode paste and then baking or formed by thermal spraying. Further, the electrodes 30a and 30b may be formed by bonding a metal plate or an alloy plate.

The thickness of the electrodes 30a and 30b is preferably about 5 to 30 µm in the case of baking an electrode paste, about 100 to 1000 nm in the case of dry plating such as sputtering and vapor deposition, about 10 to 100 µm in the case of thermal spraying, and about 5 to 30 µm in the case of wet plating such as electrolytic deposition and chemical deposition. Further, when bonding a metal plate or an alloy plate, the thickness of the electrodes 30a and 30b is preferably about 5 to 100 µm.

### 2. Method for Manufacturing Heater Element with Functional Material-Containing Layer

Next, a method for manufacturing a heater element with a functional material-containing layer according to the present invention will be described for illustration. First, a raw material composition containing a dispersion medium and a binder is mixed with a ceramic raw material and kneaded to prepare a green body, and then the green body is extruded to prepare a honeycomb formed body. Additives such as a dispersant, a semiconductor-forming agent, a shifter, a metal oxide, a property improving agent, and a conductor powder can be added to the raw material composition, if necessary. In extrusion molding, a die having a desired overall shape, cell shape, partition wall thickness, cell density and the like can be used.

The ceramic raw material is a raw material for a portion that remains after firing and constitutes the skeleton of the honeycomb structure as ceramics. The ceramic raw material can be provided, for example, in the form of powder. As the ceramic raw material, oxides and carbonate raw materials such as TIO₂ and BaCO₃, which can be the main components of barium titanate, can be used. Further, semiconductor-forming agents such as Y, La, Ce, Pr, Nd, Sm, Eu, Gd, Tb, Dy, Ho, Er, Tm, Yb and Lu, low temperature side shifters such as Sr, Sn and Zr, high temperature side shifters such as (Bi-Na), (Bi-K), property improving agents such as Mn, and oxides, carbonates, or oxalates that become oxides after firing may be used. Conductor powders such as carbon black and nickel may be added to control conductivity.

Examples of the dispersion medium include water or a mixed solvent of water and an organic solvent such as alcohol, and water can be particularly preferably used.

Examples of the binder include organic binders such as methyl cellulose, hydroxypropoxyl cellulose, hydroxyethyl cellulose, carboxymethyl cellulose, and polyvinyl alcohol. In particular, it is preferable to use methyl cellulose and hydroxypropoxyl cellulose in combination. Further, the binder content is preferably 4 parts by mass or more, more preferably 5 parts by mass or more, and 6 parts by mass or more, with respect to 100 parts by mass of the ceramic raw material, from the viewpoint of increasing the strength of the honeycomb formed body. The binder content is preferably 9 parts by mass or less, more preferably 8 parts by mass or less, and even more preferably 7 parts by mass or less, with respect to 100 parts by mass of the ceramic raw material, from the viewpoint of suppressing the occurrence of cracking due to abnormal heat generation in the firing step. For the binder, one type may be used alone, or two or more types may be used in combination.

As the dispersant, a surfactant such as ethylene glycol, dextrin, fatty acid soap, and polyalcohol can be used. For the dispersant, one type may be used alone, or two or more types may be used in combination. The content of the dispersant is preferably 0 to 2 parts by mass with respect to 100 parts by mass of the ceramic raw material.

Next, the obtained honeycomb formed body is dried. In the drying step, conventionally known drying methods such as hot wind drying, microwave drying, dielectric drying, reduced pressure drying, vacuum drying and freeze drying can be used. Among them, a drying method that combines hot wind drying with microwave drying or dielectric drying is preferable because the entire formed body can be dried quickly and uniformly.

Then, the dried honeycomb formed body can be fired to manufacture a honeycomb structure. It is also possible to perform a degreasing step for removing the binder before firing. The firing conditions can be appropriately determined depending on the material of the honeycomb formed body. For example, when the material of the honeycomb formed body contains barium titanate as a main component, the firing temperature is preferably 1100 to 1400° C., and more preferably 1200 to 1300° C. The firing time is preferably about 1 to 4 hours.

The atmosphere for carrying out the degreasing step may be, for example, an air atmosphere, an inert atmosphere, or a reduced pressure atmosphere. Among these, it is preferable to use an inert atmosphere in combination with a reduced pressure atmosphere that prevent insufficient firing due to the oxidation of the raw material and easily reduce the oxide contained in the raw material.

The furnace for firing is not particularly limited, and an electric furnace, a gas furnace or the like can be used.

A pair of electrodes can be bonded to the honeycomb structure obtained in this manner. The electrodes can be formed on the inlet end surface and the outlet end surface of the honeycomb structure, by metal deposition methods such as sputtering, vapor deposition, electrolytic deposition, and chemical deposition. Further, the electrodes can also be formed by applying an electrode paste on the inlet end surface and the outlet end surface of the honeycomb structure, and then by baking. Further, they can be formed by thermal spraying. The electrodes may be composed of a single layer, but it may be composed of a plurality of electrode layers having different compositions. When the electrodes are formed on the end surfaces by the above method, the cells can be prevented from being blocked by setting the thickness of the electrode layers so as not to be excessively large. For example, the thickness of the electrodes is preferably about 5 to 30 µm in the case of baking a paste, about 100 to 1000 nm in the case of dry plating such as sputtering and vapor deposition, about 10 to 100 µm in the case of thermal spraying, and about 5 to 30 µm in the case of wet plating such as electrolytic deposition and chemical deposition.

Next, by forming the functional material-containing layer 20 on the partition walls 14 of the honeycomb heater device thus obtained, a heater element with a functional material-containing layer can be obtained.

The method for forming the functional material-containing layer 20 is not particularly limited, and examples thereof include the following methods corresponding to the above-mentioned (Embodiment 1) to (Embodiment 6).

In the case of (Embodiment 1), first, a slurry containing a functional material, an organic binder and water was poured into the cells 13 of the honeycomb structure 10 from the side of the inlet end surface 12a, and the slurry is applied to the partition walls 14 by suctioning from the side of the outlet end surface 12b using a negative pressure. Alternatively, the slurry may be applied to the partition walls 14 by filling the inside of the cells 13 of the honeycomb structure 10 with the slurry by immersion or the like, and then removing the excess slurry by air blow from the side of the inlet end surface 12a. In order to control the viscosity of the slurry, a dispersant or a thickener may be added to the slurry.

Further, the thickness of the slurry layer is made uniform by performing the air blow and/or suction from the side of the end surface opposite to the previous one.

Then, the functional material-containing layer 20 can be formed on the partition walls 14 by drying the slurry. Drying can be performed while heating the honeycomb heater device to a temperature of, for example, about 120 to 600° C.

Next, the portion of the honeycomb structure 10 where the second region should be formed is immersed in a slurry containing a functional material, an organic binder and water for a predetermined time. Then, the excess slurry is removed by air blow from the side of the inlet end surface 12a of the honeycomb structure 10 and/or by suction from the side of the outlet end surface 12b. In order to control the viscosity of the slurry, a dispersant or a thickener may be added to the slurry.

Further, the thickness of the slurry layer is made uniform by performing the air blow and/or suction from the side of the end surface opposite to the previous one.

Then, the functional material-containing layer 20 can be formed on the partition walls 14 by drying the slurry. Drying can be performed while heating the honeycomb heater device to a temperature of, for example, about 120 to 600° C.

The series of steps of slurry application and drying may be carried out only once, but by repeating the steps a plurality of times, the functional material-containing layer 20 having a desired amount and thickness can be provided on the partition walls 14.

In the case of (Embodiment 2), a slurry containing a functional material, an organic binder and water was poured into the cells 13 of the honeycomb structure 10 from the side of the inlet end surface 12a, and the slurry is applied to the partition walls 14 by suctioning from the side of the outlet end surface 12b using a negative pressure. Alternatively, the slurry may be applied to the partition walls 14 by filling the inside of the cells 13 of the honeycomb structure 10 with the slurry by immersion or the like, and then removing the excess slurry by air blow from the side of the inlet end surface 12a. By blowing the air such that the inlet end surface 12a is upwind, it becomes possible to increase the thickness of the functional material-containing layer 20 toward the outlet end surface 12b. In order to control the viscosity of the slurry, a dispersant or a thickener may be added to the slurry.

Then, the functional material-containing layer 20 can be formed on the partition walls 14 by drying the slurry. Drying can be performed while heating the honeycomb heater device to a temperature of, for example, about 120 to 600° C.

The series of steps of slurry application and drying may be carried out only once, but by repeating the steps a plurality of times, the functional material-containing layer 20 having a desired amount and thickness can be provided on the partition walls 14.

In the case of (Embodiment 3), first, a slurry containing a functional material, an organic binder and water was poured into the cells 13 of the honeycomb structure 10 from the side of the inlet end surface 12a, and the slurry is applied to the partition walls 14 by suctioning from the side of the outlet end surface 12b using a negative pressure. Alternatively, the slurry may be applied to the partition walls 14 by filling the inside of the cells 13 of the honeycomb structure 10 with the slurry by immersion or the like, and then removing the excess slurry by air blow from the side of the inlet end surface 12a. In order to control the viscosity of the slurry, a dispersant or a thickener may be added to the slurry.

Then, the air blow and/or suction is performed from the side of the end surface opposite to the previous one, and by adjusting the air blow conditions and/or the suction conditions at the time, a slurry layer having a partially uniform thickness is formed.

Then, the functional material-containing layer 20 can be formed on the partition walls 14 by drying the slurry. Drying can be performed while heating the honeycomb heater device to a temperature of, for example, about 120 to 600° C.

The series of steps of slurry application and drying may be carried out only once, but by repeating the steps a plurality of times, the functional material-containing layer 20 having a desired amount and thickness can be provided on the partition walls 14.

In the case of (Embodiment 4), first, a portion of the honeycomb structure 10 where the second region should be formed is immersed in a slurry containing a functional material, an organic binder and water for a predetermined time, so that the inside of the cells 13 of the honeycomb structure 10 is filled with the slurry. Then, the excess slurry is removed by air blow from the side of the inlet end surface 12a and/or by suction from the side of the outlet end surface 12b of the honeycomb structure 10. In order to control the viscosity of the slurry, a dispersant or a thickener may be added to the slurry.

Further, the thickness of the slurry layer is made uniform by performing the air blow and/or suction from the side of the end surface opposite to the previous one.

Then, the functional material-containing layer 20 can be formed on the partition walls 14 by drying the slurry. Drying can be performed while heating the honeycomb heater device to a temperature of, for example, about 120 to 600° C.

The series of steps of slurry application and drying may be carried out only once, but by repeating the steps a plurality of times, the functional material-containing layer 20 having a desired amount and thickness can be provided on the partition walls 14.

In the case of (Embodiment 5), first, a portion of the honeycomb structure 10 where the second region should be formed is immersed in a slurry containing a functional material, an organic binder and water for a predetermined time, so that the inside of the cells 13 of the honeycomb structure 10 is filled with the slurry. Then, the excess slurry is removed by air blow from the side of the inlet end surface 12a and/or by suction from the side of the outlet end surface 12b of the honeycomb structure 10. By blowing the air such that the inlet end surface 12a is upwind, it becomes possible to increase the thickness of the functional material-containing layer 20 toward the outlet end surface 12b. In order to control the viscosity of the slurry, a dispersant or a thickener may be added to the slurry.

Then, the functional material-containing layer 20 can be formed on the partition walls 14 by drying the slurry. Drying can be performed while heating the honeycomb heater device to a temperature of, for example, about 120 to 600° C.

The series of steps of slurry application and drying may be carried out only once, but by repeating the steps a plurality of times, the functional material-containing layer 20 having a desired amount and thickness can be provided on the partition walls 14.

In the case of (Embodiment 6), first, a portion of the honeycomb structure 10 where the second region should be formed is immersed in a slurry containing a functional material, an organic binder and water for a predetermined time, so that the inside of the cells 13 of the honeycomb structure 10 is filled with the slurry. Then, the excess slurry is removed by air blow from the side of the inlet end surface 12a and/or by suction from the side of the outlet end surface 12b of the honeycomb structure 10. In order to control the viscosity of the slurry, a dispersant or a thickener may be added to the slurry.

Then, the air blow and/or suction is performed from the side of the end surface opposite to the previous one, and by adjusting the air blow conditions and/or the suction conditions at the time, a slurry layer having a partially uniform thickness is formed.

Then, the functional material-containing layer 20 can be formed on the partition walls 14 by drying the slurry. Drying can be performed while heating the honeycomb heater device to a temperature of, for example, about 120 to 600° C.

The series of steps of slurry application and drying may be carried out only once, but by repeating the steps a plurality of times, the functional material-containing layer 20 having a desired amount and thickness can be provided on the partition walls 14.

### 3. Vehicle Compartment Purification System

According to one embodiment of the present invention, there is provided a vehicle compartment purification system comprising the above-mentioned heater element with a functional material-containing layer. The vehicle compartment purification system can be suitably used for various vehicles such as automobiles.

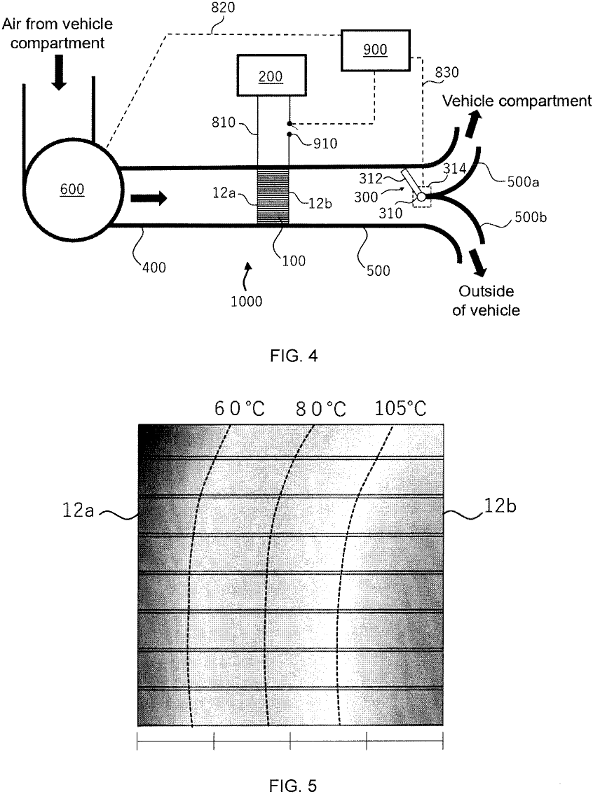

FIG. 4 is a schematic diagram showing the configuration of the vehicle compartment purification system according to an embodiment of the present invention.

The vehicle compartment purification system 1000 comprises:
at least one heater element 100;
a power supply 200 such as a battery for applying a voltage to the heater element 100;
an inflow piping 400 communicating the vehicle compartment with the inlet end surface 12a of the heater element 100;
an outflow piping 500 having a first path 500a communicating the outlet end surface 12b of the heater element 100 with the vehicle compartment; and
a ventilator 600 for allowing air from the vehicle compartment to flow into the inlet end surface 12a of the heater element 100 via the inflow piping 400.

In addition to the first path 500a, the outflow piping 500 may have a second path 500b that communicates the outlet end surface 12b of the heater element 100 with the outside of the vehicle. Further, the outflow piping 500 may have a switching valve 300 capable of switching the flow of air flowing through the outflow piping 500 between the first path 500a and the second path 500b.

The vehicle compartment purification system 1000 may have:
a first mode in which the voltage applied from the power supply 200 is turned off, the switching valve 300 is switched such that the air flowing through the outflow piping 500 passes through the first path 500a, and the ventilator 600 is turned on, and
a second mode in which the voltage applied from the power supply 200 is turned on, the switching valve 300 is switched such that the air flowing through the outflow piping 500 passes through the second path 500b, and the ventilator 600is turned on.

The vehicle compartment purification system 1000 may comprise a controller 900 capable of performing switching between the first mode and the second mode. The controller 900 may be configured such that, for example, the first mode and the second mode can be executed alternately. By repeating the switching between the first mode and the second mode in a certain cycle, the components to be removed in the vehicle compartment can be stably discharged to the outside of the vehicle.

In the first mode, the air in the vehicle compartment is purified. Specifically, the air from the vehicle compartment flows into the inlet end surface 12a of the heater element 100 through the inflow piping 400, passes through the inside of the heater element 100, and then flows out from the outlet end surface 12b of the heater element 100. The component to be removed from the vehicle compartment is removed by being captured or the like by the functional material while passing through the heater element 100. The clean air flowing out from the outlet end surface 12b of the heater element 100 is returned to the vehicle compartment through the first path 500a of the outflow piping 500.

In the second mode, the functional material is regenerated. Specifically, the air from the vehicle compartment flows into the inlet end surface 12a of the heater element 100 through the inflow piping 400, passes through the inside of the heater element 100, and then flows out from the outlet end surface 12b of the heater element 100. The heater element 100 generates heat when energized, and thereby the functional material carried on the heater element 100 is heated. Therefore, the components to be removed captured by the functional material is desorbed from the functional material, or is reacted.

In order to promote the desorption of the components to be removed captured by the functional material, it is preferable to heat the functional material to a temperature equal to or higher than the desorption temperature depending on the type of the functional material. For example, when an adsorbent is used as the functional material, it is preferable to heat at least a part, preferably the whole of the functional material to 70 to 150° C., more preferably 80 to 140° C., and even more preferably 90 to 130° C. Further, it is desirable that the second mode is performed for a time until the functional material is sufficiently regenerated. Although it depends on the type of the functional material, for example, when an adsorbent is used as the functional material, in the second mode, the functional material is preferably heated in the above temperature range for 1 to 10 minutes, more preferably for 2 to 8 minutes, and even more preferably for 3 to 6 minutes.

The air from the vehicle compartment flows out from the outlet end surface 12b of the heater element 100, entraining the components to be removed that has been desorbed from the functional material when passing through the heater element 100. The air containing the components to be removed that has flowed out from the outlet end surface 12b of the heater element 100 is discharged to the outside of the vehicle through the second path 500b of the outflow piping 500.

Switching of the applied voltage to the heater element 100 between on and off may be performed by, for example, electrically connecting the power supply 200 and the pair of electrodes 30a and 30b of the heater element 100 with an electric wire 810, and operating a power switch 910 provided on the way. The controller 900 can execute the operation of the power switch 910.

Switching of the ventilator 600 between on and off may be performed by, for example, electrically connecting the controller 900 and the ventilator 600 with an electric wire 820 or wirelessly, and operating a switch (not shown) of the ventilator 600 with the controller 900. The ventilator 600 can also be configured such that the amount of ventilation can be changed by the controller 900.

Switching of the switching valve 300 may be performed by, for example, electrically connecting the controller 900 and the switching valve 300 with an electric wire 830 or wirelessly, and operating a switch (not shown) of the switching valve 300 with the controller 900.

The switching valve 300 is not particularly limited as long as it is a valve that is electrically driven and has a function of switching the flow paths, and examples thereof include an electromagnetic valve and an electric valve. In one embodiment, the switching valve 300 comprises an open/close door 312 supported by a rotary shaft 310, and an actuator 314 such as a motor that rotates the rotary shaft 310. The actuator 314 is configured to be controllable by the controller 900.

In the vehicle compartment purification system 1000, it is desirable that the heater element 100 be arranged at a position close to the vehicle compartment from the viewpoint of stably ensuring the above functions. Therefore, from the viewpoint of preventing electric shock, the drive voltage is preferably 60 V or less. Since the honeycomb structure 10 used in the heater element 100 has a low electrical resistance at room temperature, the honeycomb structure 10 can be heated with this low drive voltage. In addition, the lower limit of the drive voltage is not particularly limited, but is preferably 10 V or more. If the drive voltage is less than 10 V, the electric current at the time of heating the honeycomb structure 10 becomes large, so that it is necessary to make the electric wire 810 thick.

In addition, in the embodiment shown in FIG. 4, the ventilator 600 is installed on the upstream side of the heater element 100. More specifically, the ventilator 600 is installed on the way of the inflow piping 400 that communicates the heater element 100 with the vehicle compartment, and the air that has passed through the ventilator 600 is pushed to flow into the heater element 100. Alternatively, the ventilator 600 may be installed downstream of the heater element 100. In this case, the ventilator 600 can be installed on the way of the outflow piping 500, for example, and the air that has passed through the inflow piping 400 is sucked to flow into the heater element 100.

### 4. Simulation

The results of simulating the temperature distribution inside the honeycomb structure when heat is generated while flowing the air from the inlet end surface toward the outlet end surface of the honeycomb structure are shown.

### Specifications of Honeycomb Structure

The specifications of the honeycomb structure used in the simulation are as follows.
Cross-section and end surface shape of the honeycomb structure orthogonal to the flow path direction: quadrangle
Cell shape orthogonal to the flow path direction: Square
Thickness of the partition walls: 0.1016 mm
Cell density: 62 cells/cm²
Cell pitch: 1.270 mm
Open frontal area of cells: 0.85
Size of cross-section orthogonal to the flow path direction of the honeycomb structure: 10 mm × 0.635 mm
Length of honeycomb structure in the flow path direction: 10 mm
Volume resistivity of the material constituting the outer peripheral wall and partition walls at 25° C.: 14 Ω·cm (almost no change up to 120° C.)
Curie point of the material constituting the outer peripheral wall and partition walls: 120° C. (barium titanate is assumed to be used)
Density of the materials constituting the outer peripheral wall and partition walls: 4500 kg/m³
Specific heat of the material constituting the outer peripheral wall and partition walls: 590 J/kg/K

### Heating Test

A heating test was simulated to investigate the temperature distribution in a steady state inside the honeycomb structure when the air (initial temperature = 20° C.) is flowed through the cells of the honeycomb structure at 0.13 m/sec from the inlet end surface toward the outlet end surface while applying a constant voltage of 12 V between the inlet end surface and the outlet end surface of the honeycomb structure. For the simulation, Fluent Ver2021-R1 (available from Ansys, Inc.) was used.

The results are shown in FIG. 5. As can be understood from this result, in the region extending from the inlet side over about ¼ of the length of the honeycomb structure, even if a functional material is carried, it is difficult to heat the honeycomb structure to 60° C. or higher, which is advantageous for regeneration, so that the functional material cannot be effectively utilized. Conversely, it can be understood that the ratio of functional material that can be effectively utilized increases by not providing functional material or reducing the thickness of the functional materials in this region.

Description of Reference Numerals
11: Outer peripheral wall
12a: Inlet end surface
12b: Outlet end surface
13: Cell
14: Partition wall
20: Functional material-containing layer
30a: Electrode
30b: Electrode
100: Heater element
200: Power supply
300: Switching valve
310: Rotating shaft
312: Open/close door
314: Actuator
400: Inflow piping
500: Outflow piping
500a: First path
500b: Second path
600: Ventilator
810: Electric wire
820: Electric wire
830: Electric wire
900: Controller
910: Power switch
1000: Vehicle compartment purification system

1. A heater element, comprising a honeycomb structure and a functional material-containing layer,
wherein the honeycomb structure has an outer peripheral wall and partition walls provided inside the outer peripheral wall, the partition walls partitioning a plurality of cells that form flow paths extending from an inlet end surface to an outlet end surface, and at least the partition walls are made of a material having PTC characteristics, and
wherein the functional material-containing layer is provided on a surface of the partition walls, and a thickness of the functional material-containing layer increases from the inlet end surface toward the outlet end surface.

2. The heater element according to claim 1, having a region where the thickness of the functional material-containing layer is 0 from the inlet end surface over a predetermined length in a direction in which the flow paths extend.

3. The heater element according to claim 2, wherein the predetermined length is ⅒ or more and ½ or less with respect to a length in the direction in which the flow paths extend in the honeycomb structure.

4. The heater element according to claim 1, having a region where the thickness of the functional material-containing layer continuously increases toward the outlet end surface.

5. The heater element according to claim 1, having
a first region where the thickness of the functional material-containing layer is 0 from the inlet end surface over a predetermined length in a direction in which the flow paths extend;
a second region adjacent to an outlet side end portion of the first region, extending over a predetermined length in the direction in which the flow paths extend, where the thickness of the functional material-containing layer continuously increases toward the outlet end surface; and
a third region adjacent to an outlet side end portion of the second region, extending to the outlet end surface in the direction in which the flow paths extend, where the thickness of the functional material-containing layer is constant till the outlet end surface.

6. The heater element according to claim 5,
wherein the predetermined length of the first region in the direction in which the flow paths extend is ¼ or more and ⅓ or less with respect to the length in the direction in which the flow paths extend in the honeycomb structure, and
the predetermined length of the second region in the direction in which the flow paths extend is ⅙ or more and ¼ or less with respect to the length in the direction in which the flow paths extend in the honeycomb structure.

7. The heater element according to claim 1, wherein the thickness of the functional material-containing layer is 300 µm or less at the maximum.

8. The heater element according to claim 1, having a continuous regionextending in a direction in which the flow paths extend with a length of ½ or more and 9/10 or less with respect to a length of the flow paths, where thethickness of the functional material-containing layer is 1/100 or more and ⅓ or less of a hydraulic diameter of the cells.

9. The heater element according to claim 1, wherein an amount of the functional material-containing layer is 50 g/L or more and 500 g/L or less with respect to a volume of the honeycomb structure.

10. The heater element according to claim 1, wherein the functional material-containing layer comprises a functional material having a function of adsorbing one or more selected from water vapor, carbon dioxide, and an odor component.

11. The heater element according to claim 1, wherein the functional material-containing layer comprises a catalyst.

12. The heater element according to claim 1, wherein the honeycomb structure has a partition wall thickness of 0.125 mm or less, a cell density of 100 cells/cm² or less, and a cell pitch of 1.0 mm or more.

13. The heater element according to claim 1, wherein the honeycomb structure has a partition wall thickness of 0.08 mm or more and 0.36 mm or less, a cell density of 2.54 cells/cm² or more and 140 cells/cm² or less, and an open frontal area of the cells of 0.80 or more.

14. The heater element according to claim 1, wherein the material having PTC characteristics has a volume resistivity of 0.5 Ω·cm or more and 20 Ω·cm or less at 25° C.

15. The heater element according to claim 1, wherein the material having PTC characteristics is composed of a material comprising barium titanate as a main component and substantially free of lead.

16. The heater element according to claim 1, wherein the heater element comprises a pair of electrodes on the inlet end surface and the outlet end surface.

17. A vehicle compartment purification system, comprising:
at least one heater element according to claim 1;
a power supply for applying a voltage to the heater element;
an inflow piping communicating the vehicle compartment with the inlet end surface of the heater element;
an outflow piping having a first path communicating the outlet end surface of the heater element with the vehicle compartment; and
a ventilator for allowing air from the vehicle compartment to flow into the inlet end surface of the heater element via the inflow piping.

18. The vehicle compartment purification system according to claim 17,
wherein in addition to the first path, the outflow piping has a second path communicating the outlet end surface of the heater element with an outside of the vehicle,
the outflow piping has a switching valve capable of switching a flow of air flowing through the outflow piping between the first path and the second path,
wherein the vehicle compartment purification system comprises a controller capable of switching between a first mode and a second mode,
wherein in the first mode, the voltage applied from the power supply is turned off, the switching valve is switched such that the air flowing through the outflow piping passes through the first path, and the ventilator is turned on, and
in the second mode, the voltage applied from the power supply is turned on, the switching valve is switched such that the air flowing through the outflow piping passes through the second path, and the ventilator is turned on.
